(19) United States
(12) Patent Application Publication
(10) Pub. No.: US 2013/0015845 A1
(43) Pub. Date: Jan. 17, 2013

(54) ABSOLUTE ANGULAR POSITION SENSOR USING TWO MAGNETORESISTIVE SENSORS

(71) Applicant: Joshua Fox, Freeport, IL (US)

(72) Inventor: Joshua Fox, Freeport, IL (US)

(73) Assignee: HONEYWELL INTERNATIONAL INC., Morristown, NJ (US)

(21) Appl. No.: 13/179,778

(22) Filed: Jul. 11, 2011

(51) Int. Cl. G01B 7/30

(52) U.S. Cl. 324/207.21; 324/207.25

(57) ABSTRACT

In one example, a rotary position sensor is provided. The rotary position sensor comprises an integrated circuit, a first magnetic field angular position sensor, and a second magnetic field angular position sensor. The first magnetic field angular position sensor provides at least a first signal to the integrated circuit and the second magnetic field angular position sensor provides at least a second signal to the integrated circuit. The integrated circuit is configured to provide an output signal indicative of an angular position of a magnetic field, wherein the output signal is based at least on the first signal and the second signal, and wherein the output signal has an angular range of approximately 360 degrees.

### TECHNICAL FIELD

The disclosure relates to magnetic field sensors, and more particularly, to magnetic field sensors configured to sense an angular position of a magnetic field.

### BACKGROUND

Some rotary position sensors are used to determine an angular position of a device. Such a device may be, for example, a gear or other rotatable device. To determine an angular position of the device, an array of magnetic field angular position sensors is sometimes used in conjunction with a magnet attached to the device. In some cases, the array of magnetic field angular position sensors is positioned concentrically around the device such that the magnet will sweep close to each sensor of the array as the device rotates.

### SUMMARY

In one example, a rotary position sensor is provided. The rotary position sensor comprises an integrated circuit, a first magnetic field angular position sensor, and a second magnetic field angular position sensor. The first magnetic field angular position sensor provides at least a first signal to the integrated circuit and the second magnetic field angular position sensor provides at least a second signal to the integrated circuit. The integrated circuit is configured to provide an output signal indicative of an angular position of a magnetic field, wherein the output signal is based at least on the first signal and the second signal, and wherein the output signal has an angular range of approximately 360 degrees.

In another example, a system comprising magnetic field source having a magnetic field is provided. The system also includes a rotary position sensor in proximity to the magnet, wherein the rotary position sensor is configured to determine an orientation the magnetic field. The rotary position sensor comprises an application specific integrated circuit (ASIC), a first magnetoresistive sensor that provides a first signal to the ASIC; and a second magnetoresistive sensor that provides a second signal to the ASIC. The ASIC is configured to provide an output signal indicative of the orientation of the magnetic field, wherein the output signal is based at least on the first signal, the second signal, an inverse of the first signal, and an inverse of the second signal.

In a further example, a method for determining rotary position is provided. The method includes receiving a first signal from a first side of a first magnetoresistive sensor and a second signal from a second side of the first magnetoresistive sensor. The method also includes receiving a third signal from a first side of a second magnetoresistive sensor, wherein the second magnetoresistive sensor is oriented at least approximately 90 degrees with respect to the first magnetoresistive sensor. The method further includes receiving a fourth signal from a second side of the second magnetoresistive sensor. The first signal is compared with the second signal and the third signal is compared with the fourth signal, wherein the first through fourth signals are related to a magnetic field incident to the first and second magnetoresistive sensors and have an angular range of approximately 180 degrees for the first cycle of the signal. The method additionally includes generating a signal indicative of an angular position of the magnetic field based on at least on the comparisons, wherein the signal indicative of an angular position has an angular range of approximately 360 degrees.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating one example of a system for determining an angular position of a magnetic field source, in accordance with one or more aspects of the present disclosure.

FIG. 2 is a schematic diagram illustrating one example of a rotary position sensor, in accordance with one or more aspects of the present disclosure.

FIG. 3A is a graph illustrating example waveforms generated on a first side and a second side of a magnetoresistive sensor, in accordance with one or more aspects of the present disclosure.

FIG. 3B is a graph illustrating an example waveform of a difference signal of the first side and the second side of the magnetoresistive sensor of FIG. 3A, in accordance with one or more aspects of the present disclosure.

FIG. 4 is a graph illustrating waveforms generated by an example sensing device, in accordance with one or more aspects of the present disclosure.

FIG. 5 is a flowchart illustrating an example method for determining an angular position of a magnetic field source, in accordance with one or more aspects of the present disclosure.

The details of one or more aspects of the disclosure are set forth in the accompanying drawings and the description below. Other features, objects, and advantages of the techniques described in this disclosure will be apparent from the description and drawings, and from the claims. In accordance with common practice, the various described features are not drawn to scale and are drawn to emphasize features relevant to the present disclosure. Like reference characters denote like elements throughout the figures and text.

### DETAILED DESCRIPTION

This disclosure is directed to techniques for magnetic field angular position sensing. The techniques may involve the use of two magnetoresistive sensors and an integrated circuit to form a rotary position sensor (also referred to herein as an angular position sensor). The rotary position sensor may be configured to generate signals indicative of the angular position of an incident magnetic field. The two magnetoresistive sensors of the rotary position sensor may be located proximate to a magnetic field source such that the magnetic field of the magnetic field source is incident upon the magnetoresistive sensors. The magnetic field source may be affixed to a rotating device, wherein the angular position of the incident magnetic field may be correlated with an angular position of the rotating device.

The signals generated by the two magnetoresistive sensors may be used in combination to generate another signal indicative of the angular position of the incident magnetic field. The signal indicative of the angular position of the incident magnetic field may be conditioned such that a single period electric signal corresponds to a larger angular range than a single period of an unconditioned signal from one magnetoresistive sensor. In this manner, the techniques of this disclosure may provide an angular position sensing signal with an increased angular range relative to that which is generated by the magnetoresistive sensors. Furthermore, one or more signals generated by one or more polarity detectors may be used in combination with the magnetoresistive sensors signals to generate a signal indicative of an absolute angular position of the incident magnetic field.

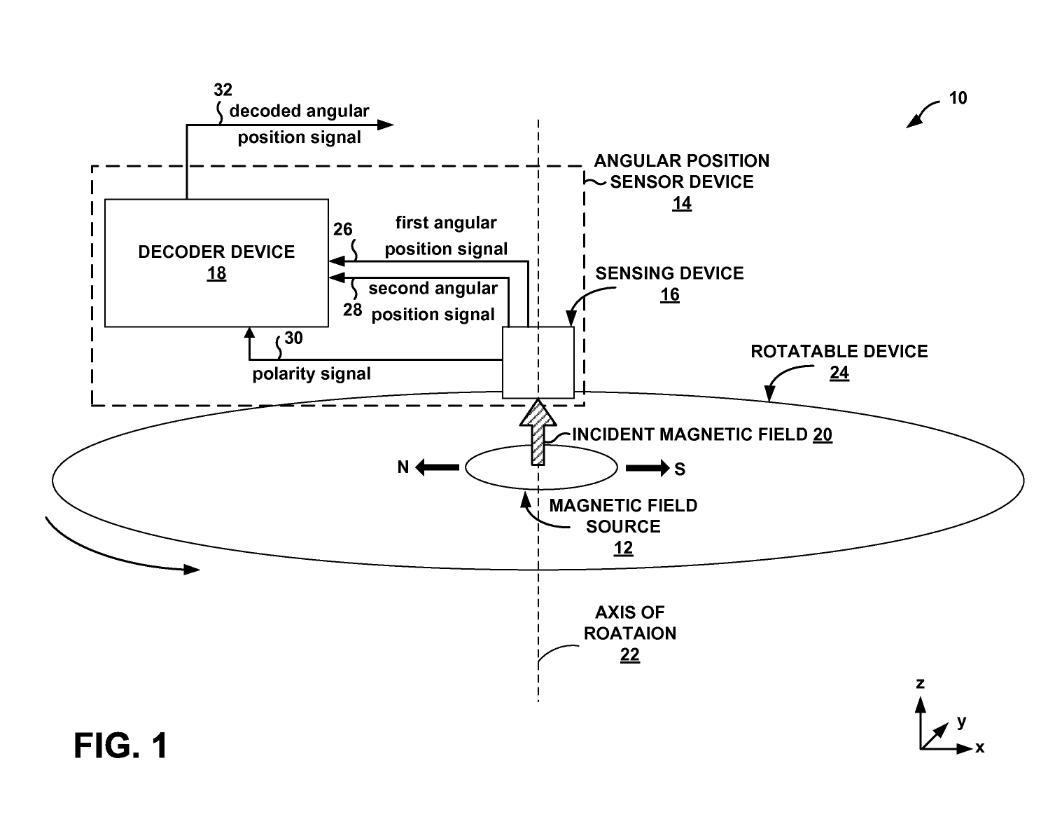

FIG. 1 is a block diagram illustrating one example of a system 10 for determining an angular position of a magnetic field source 12, in accordance with one or more aspects of the present disclosure. Magnetic field angular position sensing system 10 is configured to generate a decoded angular position signal 32 indicative of the angular position of magnetic field source 12. Magnetic field angular position sensing system 10 includes magnetic field source 12 and an angular position sensor device 14. Magnetic field source 12 is magnetically coupled to sensing angular position sensor device 14 via an incident magnetic field 20.

Magnetic field source 12 may be affixed to a rotatable device 24. In particular, magnetic field source 12 may be affixed to rotatable device 24 in many different ways, including bolting, screwing, gluing, or any other means of attachment. In some examples, affixing magnetic field source 12 to rotatable device 24 may be performed to a level of precision. Precise attachment may ensure that magnetic field source 12 is located over an axis of rotation 22 of rotatable device 24. Precise attachment may also make the approximately constant over a lifetime of the system 10. Magnetic field source 12 may be affixed to a geometric center of rotatable device 24. Rotatable device 24 may be any device free to rotate about one axis. As shown in FIG. 1, rotatable device 24 may be rotatable about an axis of rotation 22, corresponding to a z direction. Rotatable device 24 may comprise a gear, an axle, or the like. In other examples, magnetic field source 12 is not affixed to a rotatable device 24. In such an example, angular position sensor device 14 may rotate.

Magnetic field source 12 is configured to generate incident magnetic field 20. Magnetic field source 12 may be rotatable about axis of rotation 22. As magnetic field source 12 rotates around axis of rotation 22, the angular position of incident magnetic field 20 also rotates. Thus, the angular position of incident magnetic field 20 may be indicative of the angular position of magnetic field source 12. In particular, each angular position of incident magnetic field 20 may correspond to an angular position of magnetic field source 12. In some examples, the axis of rotation of incident magnetic field 20 may be approximately the same axis of rotation 22 as that of rotatable device 24.

In some examples, magnetic field source 12 may be rotated at any angle within a 360 degree angular span. In other words, in such examples, magnetic field source 12 may be able to rotate in a complete circle about axis of rotation 22. In such examples, the rotation of magnetic field source 12 causes incident magnetic field 20 to rotate through a 360 degree span.

Magnetic field source 12 may be formed from any type of magnetic source configured to generate incident magnetic field 20. In some examples, magnetic field source 12 may comprise a bar magnet, cylindrical magnet, ring magnet, or any other type of device configured to generate a magnetic field. In further examples, the incident magnetic field 20 generated by magnetic field source 12 may be of sufficient strength to saturate a magnetoresistive sensor contained within angular position sensor device 14. In further examples, the strength of incident magnetic field 20 may be anywhere between approximately 50 to approximately 400 Gauss (“G”), or greater, for an example where the magnetoresistive sensors are AMR sensors. In other examples, such as where the magnetoresistive sensors are TMR or GMR sensors, incident magnetic field 20 may have other field strengths.

Angular position sensor device 14 may be configured to receive incident magnetic field 20 and to generate decoded angular position signal 32. In some examples, decoded angular position signal 32 may output a signal corresponding to an angular position that is substantially equal to the angular position of incident magnetic field 20. In additional examples, decoded angular position signal 32 may vary with respect to change in the incident magnetic field 20 according to a substantially linear function over a 360 degree span. In other words, in such examples, the slope may be substantially constant for any angular position within a 360 degree span for a function having incident magnetic field 20 as the input value and decoded angular position signal 32 as the output value.

Angular position sensor device 14 may include a sensing device 16 and a decoder device 18. Sensing device 16 may be communicatively coupled to decoder device 18. Sensing device 16 may be configured to sense incident magnetic field 20 and to generate at least a first difference signal 26 and a second difference signal 28. As shown in FIG. 1, sensing device 16 may also be configured to generate at least one polarity signal 30 based on sensed magnetic field 20. The three signals generated by sensing device 16 may together be indicative of an absolute angular position of incident magnetic field 20 within a 360 degree span. In other examples, sensing device 16 does not generate polarity signal 30.

Magnetic position sensing involves the use of magnetic sensors to provide an indication of the angular position of a rotatable magnetic field to determine an angular position of incident magnetic field 20. Sensing device 16 may include two or more magnetoresistive sensors. The two or more magnetoresistive sensors may be configured to generate first difference signal 26 and second difference signal 28. One or more of the magnetic field angular position sensors may be an anisotropic magnetoresistive (AMR) sensor. An AMR sensor may be configured to generate one or more signals indicative of the angular position of a magnetic field such that the signals have an angular range of 180 degrees per single sinusoidal cycle. An AMR sensor may include resistive elements that are configured into one or more Wheatstone bridge configurations. In other examples, one or more of the magnetic field angular position sensors may be a giant magnetoresistive (GMR) sensor, a tunneling magnetoresistive (TMR) sensor, or any other type of magnetic sensor. As discussed herein, a Wheastone bridge or AMR sensor may be referred to as a “bridge,” wherein the signals produced are bridge signals.

One or more of the magnetic field angular position sensors may be magnetoresistive sensors. Magnetoresistivity is a change in the resistivity of a ferromagnetic material in the presence of a magnetic field. Magnetoresistive sensors output a signal related to the strength or orientation of incident magnetic field 20. However, a magnetoresistive sensor may not be able to distinguish between magnetic poles. A magnetoresistive sensor may output an analog sinusoidal signal that has a complete 360 degree cycle for a 180 degree rotation of incident magnetic field 20. That is, for every 360 degrees of rotation of incident magnetic field 20, a magnetoresistive sensor outputs an analog signal having two cycles.

In the example shown in FIG. 1, sensing device 16 may be approximately centered over magnetic field source 12. Magnetic field source 12 is affixed to rotatable device 24 over axis of rotation 22. In one example, magnetic field source 12 may be located in an approximate geometric center of rotatable device 24. In other examples, magnetic field source 12 is located proximate to a center of rotation of rotatable device 24. Locating sensing device 16 approximately over, adjacent to, or proximate to magnetic field source 12 may ensure sensing device 16 is within a detectable physical range of incident magnetic field 20.

The first and second output voltage signals 26 and 28 may be used to determine an angular position of incident magnetic field 20. For some types of angular position sensing applications, it may be desirable to have an absolute angular measurement range of 360 degrees rather than 180 degrees. For example, it may be desirable to provide a 360 degree angular measurement range when sensing the angular position of rotating device 24, such as, e.g., a steering wheel or other rotating shaft. For applications where a 360 degree angular measurement range is desired, the two sinusoidal cycles provided by an AMR sensor described above may not be sufficient to discriminate the angular position of the incident magnetic field. For example, an output value produced by an AMR sensor that corresponds to 30 degrees within a 180 degree angular measurement range may correspond to either 30 degrees or 210 degrees within a 360 degree angular measurement range. Thus, such a sensor is not able to discriminate in which half of a 360 angular span the incident magnetic field is positioned if power to the sensor is lost.

In some examples, sensing device 16 comprises two magnetoresistive sensors that each includes a Wheatstone bridge. For examples, the two magnetic field angular sensors are AMR sensors each having a Wheatstone bridge configuration. A Wheatstone bridge may comprise a plurality of resistive elements coupled in a series configuration. Each of the resistive elements may have a resistance that varies according to the magnitude and/or direction of a magnetic field that is incident upon the respective resistive element. The resistive elements within the Wheatstone bridge configurations may be formed from a Permalloy material. The Wheatstone bridge configuration may generate one or more output voltage values that are indicative of the change in resistance caused by the amplitude and direction of the magnetic field.

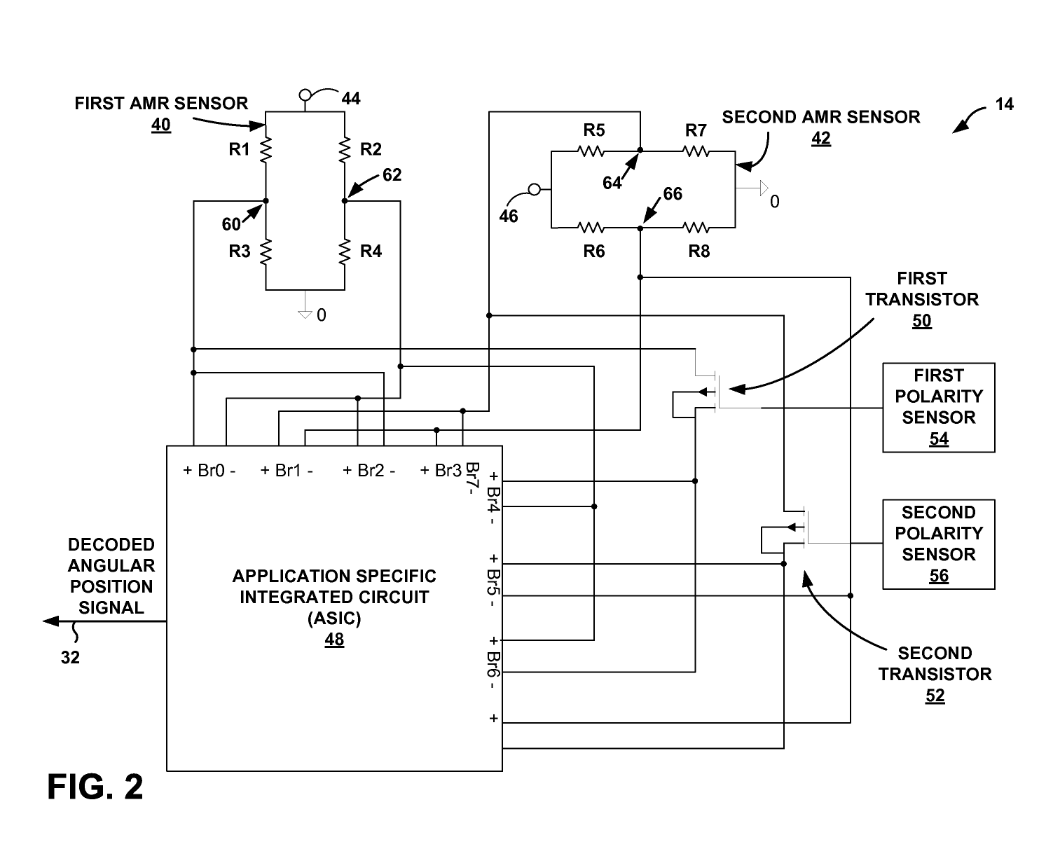

Sensing device 16 may comprise a first Wheatstone bridge and a second Wheatstone bridge, as described below with respect to FIG. 2. In such an example, the first Wheatstone bridge outputs a first difference signal 26 and the second Wheatstone bridge outputs at least a second difference signal 28. The first difference signal 26 may be a voltage difference between a first side of the first Wheatstone bridge and a second side of the first Wheatstone bridge. That is, the first Wheatstone bridge may output a first angular position signal on the first side and a second angular position signal, wherein the second angular position signal may be a voltage at a second side of the first Wheatstone bridge opposing the first side. Decoder device 18 may determine a difference voltage between the two opposing sides of the first Wheatstone bridge by subtracting the first and second angular position signals. Similarly, the second difference signal 28 is a difference voltage of the second Wheatstone bridge. The second difference signal 28 is a voltage difference of a third angular position signal from a first side of the second Wheatstone bridge and a fourth angular position signal from a second side of the second Wheatstone bridge. In some examples, the third and fourth angular position signals may be provided to decoder device 18 to determine a difference voltage between two opposing sides of a second Wheatstone bridge.

The first Wheatstone bridge may be positioned in a first orientation and the second Wheatstone bridge may be positioned in a second orientation that is rotated by approximately 90 degrees relative to the orientation of the first Wheatstone bridge. With this orientation difference, second difference signal 28 may be shifted by 90 degrees with respect to first difference signal 26.

In some examples, the angular position of incident magnetic field 20 may correspond to the angular position of those components of incident magnetic field 20 that are parallel to a plane of sensitivity of sensing device 16. The plane of sensitivity may, in some examples, correspond to a plane of sensitivity of the magnetoresistive device contained within sensing device 16, e.g., a plane defined by a Wheatstone bridge configuration within sensing device 16. In further examples, a fixed angle may be defined for sensing device 16 within the plane of sensitivity and the angular position of incident magnetic field 20 may be the angular position of incident magnetic field 20 relative to the fixed angle. As shown in FIG. 1, magnetic field source 12 may rotate in an x-y plane. Similarly, the plane of sensitivity of sensing device 16 may also be in the x-y plane. In some examples, the two or more magnetic field sensors may be affixed or attached to a common substrate. The substrate may define the plane of sensitivity for sensing device 16.

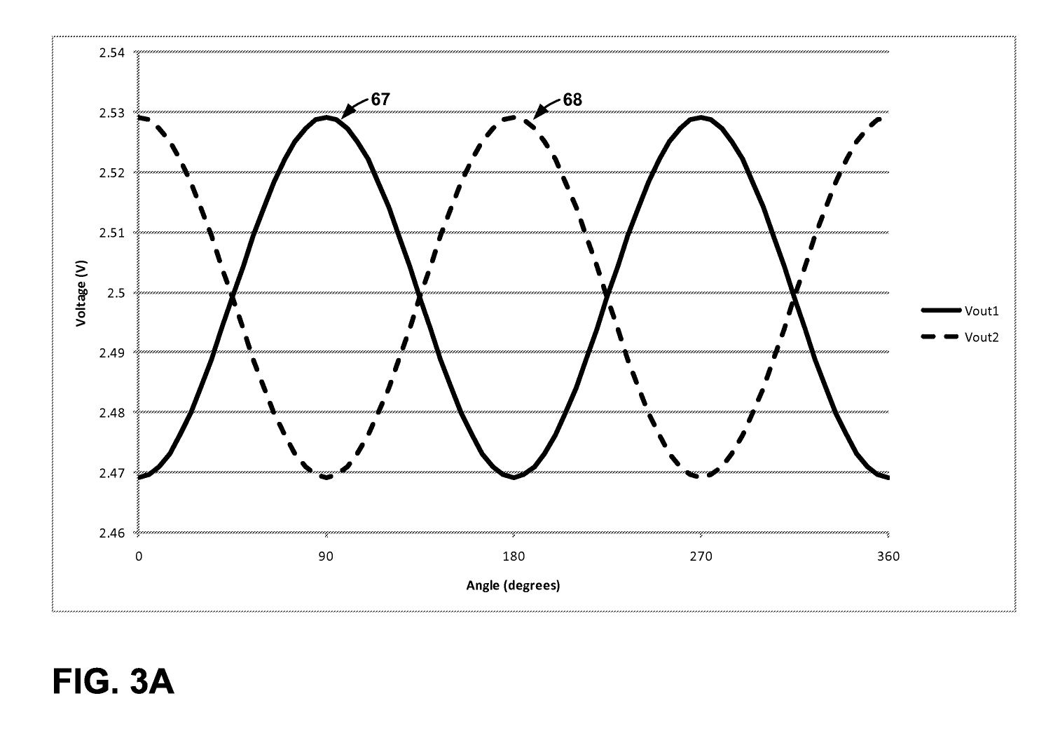

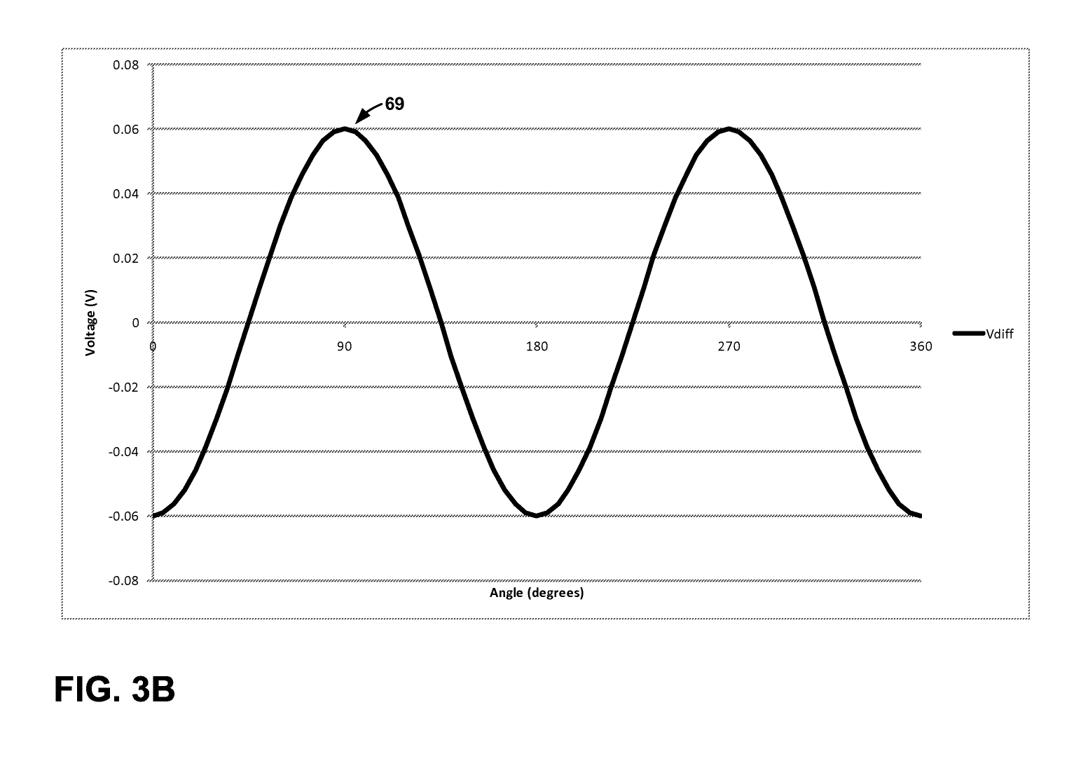

Sensing device 16 may generate difference signals 26 and 28 such that difference signals 26 and 28 vary with respect to incident magnetic field 20 according to a periodic function. Turning briefly to FIGS. 3A and 3B, examples of angular position signals and difference signals between the angular position signals of an example magnetoresistive sensor are shown.

For example, first difference signal 26 may vary with respect to incident magnetic field 20 according to a sinusoidal function. Similarly, for example, second difference signal 28 may vary with respect to incident magnetic field 20 according to a sinusoidal function. As used herein, a sinusoidal function may refer to a function that oscillates like a sine function or a cosine function with respect to the angular position of incident magnetic field 20. The sine function or cosine function may be shifted, stretched, compressed, squared, etc. First and second angular position signals 26 and 28 may be analog signals.

FIG. 3A is a graph illustrating example waveforms generated on a first side and a second side of a magnetoresistive sensor, in accordance with one or more aspects of the present disclosure. The graph shows first angular position signal 67 from a first side of a magnetoresistive sensor, such as, for example, first AMR sensor 40 in FIG. 2. A second angular position signal 68 may be from a second side of the magnetoresistive sensor. The y-axis is measured in Volts (V) while the x-axis is measured in degrees, such as degrees of rotation of a magnetic field source. As shown in FIG. 3A, first and second angular position signals 67 and 68 are approximately sinusoidal and show two cycles per 360 degrees of rotation.

FIG. 3B is a graph illustrating an example waveform of a difference signal 69 between the first side and the second side of the magnetoresistive sensor of FIG. 3A, in accordance with one or more aspects of the present disclosure. Difference signal 69 may be a difference between first angular position signal 67 and second angular position signal 68. As shown in FIG. 3B, difference signal 69 is approximately a sinusoidal signal having two cycles over 360 degrees. In one example, the difference signal 69 may be a function of sine squared.

Returning to FIG. 1, sensing device 16 may also comprise a polarity sensor that outputs polarity signal 30. An example of the polarity sensor may be a Hall Effect sensor. Polarity sensors will be discussed further below, with respect to FIG. 2. In some examples, polarity signal 30 may be a digital signal, e.g., a digital bit, indicative of the polarity of incident magnetic field 20. In further examples, polarity signal 30 may be an analog signal indicative of the polarity of incident magnetic field 20. When polarity signal 30 is an analog signal, a predetermined threshold together with the analog signal may together indicate the polarity of incident magnetic field 20. For example, an analog value of polarity signal 30 greater than a first threshold may be indicative of a first polarity and an analog value of polarity signal 30 less than or equal to the first threshold may be indicative of a second polarity.

Decoded angular position signal 32 may comprise a digital signal indicative of the angular position of magnetic field source 12. Decoded angular position signal 32 may also comprise an analog signal indicative of the angular position of magnetic field source 12. In some examples, decoded angular position signal 32 provides an absolute angular position of magnetic field source 12. An absolute angular position sensor may be able to distinguish between the poles of incident magnetic field 20.

Decoder device 18 may be configured to receive at least first difference signal 26, second difference signal 28, and polarity signal 30. Decoder device 18 may generate decoded angular position signal 32 based at least on first difference signal 26, second difference signal 28, and polarity signal 30. Decoded angular position signal 32 may be a signal indicative of the angular position of incident magnetic field 20 within a 360 degree span. In other examples, decoder device 18 generates decoded angular position signal 32 based on first difference signal 26 and second difference signal 28 without polarity signal 30.

Decoder device 18 may generate decoded angular position signal 32 at least in part by implementing a Fourier series analysis of first difference signal 26 and second difference signal 28. The first difference signal 26 and second difference signal 28 may be linearized using the Fourier series. In such examples, decoder device 18 may be referred to herein as a digital decoder device 18. When implementing a digital Fourier series, decoder device 18 may use sequential circuit elements to implement the Fourier series. As used herein, sequential circuit elements refer to circuit elements that retain a particular state after the inputs to the circuit elements are unasserted. For example, decoder device 18 may use a look-up table stored within a memory or register bank to implement the linearization with the Fourier series.

In further examples, decoder device 18 may implement an analog Fourier series analysis. In such examples, decoder device 18 may be referred to herein as an analog decoder device 18. When implementing an analog Fourier series analysis, decoder device 18 may use non-sequential circuit elements to implement the Fourier series. As used herein, non-sequential circuit elements refer to circuit elements that do not retain a particular state after the inputs to the circuit elements are unasserted. For example, decoder device 18 may use combinational circuit elements to implement the Fourier series.

In some examples, angular position sensor device 14 may include decoder device 18 and sensing device 16 in a single package. In other examples, sensing device 16 comprises a single package including at least two magnetic field angular position sensors, wherein decoder device 18 is located external to the package. In other examples, sensing device 16 comprises a single package including two magnetic field angular position sensors and at least one polarity sensor.

FIG. 2 is a schematic diagram illustrating one example of an angular position sensor device 14, in accordance with one or more aspects of the present disclosure. FIG. 2 illustrates only one particular example of angular position sensor device 14, and many other example embodiments of angular position sensor device 14 may be used in other instances. Angular position sensor device 14 may detect an incident magnetic field and output decoded angular position signal 32 related to an orientation of the incident magnetic field.

Angular position sensor device 14 comprises two magnetic field angular position sensors, first AMR sensor 40 and second AMR sensor 42. Both AMR sensors 40 and 42 are formed in a Wheatstone bridge configuration, each comprising four resistors that may include a ferromagnetic material that is susceptible to magnetoresistivity. First AMR sensor 40 comprises four resistors R1 through R4. A voltage may be applied to first AMR sensor at a node 44 between R1 and R2. The voltage at node 44 may be, for example, approximately up to and including 5 Volts (V), or any other suitable voltage. First AMR sensor 40 may be grounded between resistors R3 and R4. The resistors R1 through R4 may have approximately the same resistance. In other examples, one or more of resistors R1 through R4 may have different resistances as compared to the other resistors.

Similar to first AMR sensor 40, second AMR sensor 42 may comprise four resistors R5 through R8. A voltage may be applied to first AMR sensor at a node 46 between R5 and R6. Likewise, the voltage applied to node 46 may be approximately 5 V or another voltage. Second AMR sensor 42 may be grounded between resistors R7 and R8. The resistors R5 through R8 may have approximately the same resistance. The resistances of resistors R5 through R8 may be approximately the same as the resistance of resistors R1 through R4 in first AMR sensor 40. In other examples, resistors R5 through R8 may have different resistances.

First AMR sensor 40 and second AMR sensor 42 may be coupled to an application specific integrated circuit (ASIC) 48. ASIC 48 may receive analog signals from first AMR sensor 40 and second AMR sensor 42 and converts the signals into decoded angular position signal 32 having a 360 degree angular range. ASIC 48 may have 16 inputs. In other examples, ASIC 48 may have other numbers of inputs. If more inputs are needed, one or more ASICs such as ASIC 48 may be daisy-chained to ASIC 48. Some of these inputs to ASIC 48 may be coupled as bridges. As shown in FIG. 2, ASIC 48 has 16 inputs combined into eight bridges, Br0 through Br7. Each bridge may have a positive and a negative input. A binary operation may be performed on the two signals inputted into a bridge. A binary operation may be any mathematical operation on two inputs. For example, a signal received at a negative input of Br0 may be subtracted from a signal received at a positive input of Br0.

When first AMR sensor 40 passes in proximity to a magnetic field source, such as magnetic field source 12 of FIG. 1, a magnetic field may be incident upon first AMR sensor 40, such as incident magnetic field 20. Incident magnetic field 20 exposes the resistors R1 through R4 to different levels of magnetoresistivity, based upon the strength and orientation of incident magnetic field 20 at the particular resistor. For example, if incident magnetic field 20 is first incident upon resistors R1 and R3, the level of magnetoresistivity may be different for resistors R1 and R3 than for resistors R2 and R4. Thus, the voltage at node 60 may differ from the voltage at node 62. This difference voltage may indicate an orientation of incident magnetic field 20.

In order to determine such a difference voltage, first AMR sensor 40 may be coupled to ASIC 48 at one or more inputs. As shown in FIG. 2, first AMR sensor 40 is coupled to ASIC 48 at two outputs, node 60 and node 62. Node 60 detects the voltage between resistors R1 and R3 and node 62 detects the voltage between resistors R2 and R4. Similarly, second AMR sensor 42 may be coupled to ASIC 48 at one or more inputs. In FIG. 2, second AMR sensor 42 is coupled to ASIC 48 at two outputs, node 64 and node 66. Node 64 detects the voltage between resistors R5 and R7 and node 66 detects the voltage between resistors R6 and R8.

For example, a difference voltage may be obtained between the voltages at nodes 60 and 62. In such an example, the voltage at node 60 may be provided to a positive input of bridge Br0 while the voltage at node 62 may be provided to a negative input of bridge Br0. As used herein, the terms “positive” and “negative” as applied to the inputs of ASIC 48 are used merely as a convention to refer to the two inputs. ASIC 48 may subtract the voltage at node 62 from the voltage at node 60 to determine a difference voltage. In an example where the magnetoresistive sensors are AMR sensors, this difference voltage may be up to approximately 60 millivolts (mV). However, in other examples, other differences in voltages may be between the opposing sides of first AMR sensor 40. The difference voltage may also be different in examples using TMR or GMR sensors.

Angular position sensor device 14 may also comprise a first transistor 50 and a second transistor 52. First and second transistors 50 and 52 may comprise any type of field effect transistor (FET), for example. Both transistors 50 and 52 comprise a source, a gate, and a drain. In other examples, angular position sensor device 14 may include another switching device instead of first transistor 50 and second transistor 52. For example, angular position sensor device 14 may include one or more multiplexers, digital logical, or another semiconductor device.

A first polarity sensor 54 may be coupled to the gate of first transistor 50. A second polarity sensor 56 may be coupled to the gate of second transistor 52. The transistors 50 and 52 may be enabled by the polarity sensors 54 and 56, respectively. In another example, angular position sensor device 14 comprises only one polarity sensor which may be coupled to the gates of both transistors 50 and 52. In yet another example, angular position sensor device 14 may not include a polarity sensor.

The first and second polarity sensors 54 and 56 may be used to sense the polarity of incident magnetic field 20. The polarity sensors 54 and 56 may be positioned in a location where incident magnetic field 20 includes directional components that are perpendicular to the plane of rotation of magnetic field source 12 that generates the incident magnetic field. When positioned in such a manner, polarity sensors 54 and 56 may provide information as to which half-spectrum of the 360 degree angular span the incident magnetic field is positioned. Examples of first and second polarity sensors 54 and 56 may include a Hall Effect sensor. This information may be used in conjunction with the output values of the first and second AMR sensors 40 and 42 to determine an output value corresponding to a 360 angular position.

In one example configuration, which is shown in FIG. 2, each node 60, 62, 64, and 66 may be coupled to ASIC 48 at four inputs. Node 60 may be coupled to ASIC 48 at a positive input of Br0 and at a negative input of Br2. Node 60 may also be coupled to ASIC 48 indirectly though coupling node 60 to a source of first transistor 50, and coupling a drain of first transistor 50 to a positive input of Br4 and a negative input of Br6. Node 62 may be coupled to ASIC 48 at a negative input of Br0, a positive input of Br2, a negative input of Br4, and a positive input of Br6. In this manner, Br2 is an inverse of Br0 and Br6 is an inverse of Br4.

Similarly, node 64 may be coupled to ASIC 48 at a positive input of Br1 and at a negative input of Br3. Node 64 may also be coupled to ASIC 48 indirectly though coupling node 64 to a source of first transistor 52, and coupling a drain of first transistor 52 to a positive input of Br5 and a negative input of Br7. Node 66 may be coupled to ASIC 48 at a negative input of Br1, a positive input of Br3, a negative input of Br5, and a positive input of Br7. In this manner, Br3 is an inverse of Br1 and Br7 is an inverse of Br5. Other configurations besides that shown in FIG. 2 are possible. Also, other techniques for signal conditioning of the magnetoresistive sensors are contemplated herein.

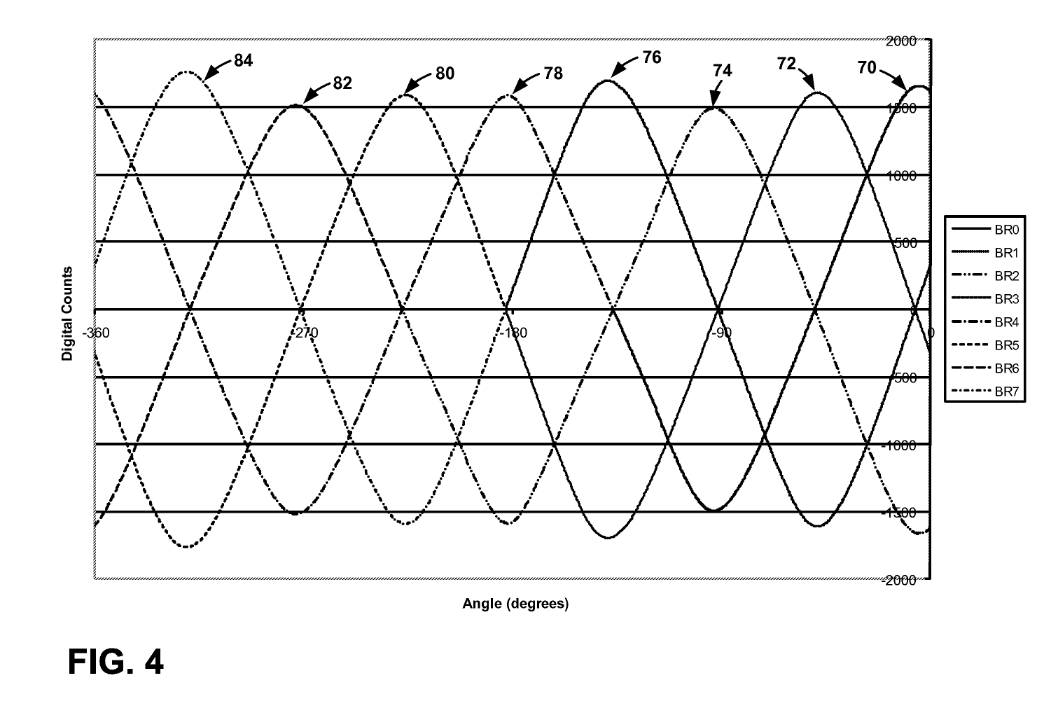

ASIC 48 may perform a Fourier series on the differential voltages at the bridges Br0 through Br7 in order to generate decoded angular position signal 32. Angular position sensor device 14 may convert a two cycle signal into a 360 degree angular range signal due, at least in part, to the approximately 90 degree phase shift of the first AMR sensor 40 to the second AMR sensor 42. Calculating a voltage difference across each of AMR sensors 40 and 42 results in two sinusoidal signals that are 90 degrees out of phase from each other. Through continued sampling at the same nodes throughout a rotation of incident magnetic field 20 over more than 180 degrees, ASIC 48 is able to apply or copy the signals for an angle range beyond the first 180 degree range. Then, by inverting each of these signals, a total of eight signals is created. Combined, these signals are able to be used to generate decoded angular position signal 32 having a 360 degree angular range. A graph showing example waveforms is shown in FIG. 4, discussed below. In other examples, the eight signals are converted to signals having 90 degree phase shifts through other means of signal processing.

ASIC 48 may further include circuitry to amplify the differential signals. ASIC 48 may further include an analog-to-digital converter for converting the amplified signals. ASIC 48 may perform a Fourier series on the amplified digital signals. A Fourier series may produce decoded angular position signal 32. Decoded angular position signal 32 may take one of many different forms, including a digital or analog signal, a 2-wire analog ratiometric, 1-wire analog ratiometric, 1-wire digital, and 4-wire push-pull programmable operate/release points. Other electrical output formats may be used, such as, for example, pulse width modulated (PWM) signals.

ASIC 48 may be configurable for each application. In other examples, more than one ASIC 48 may be used in angular position sensor device 14. For example, a master-slave circuit can be employed to daisy-chain multiple ASICs together, for example, in systems where more than one rotating device is to be measured.

In other examples, ASIC 48 may comprise another type of integrated circuit. For example, ASIC 48 may comprise a complementary metal-oxide-semiconductor (CMOS) circuit. The functionality that ASIC 48 performs may be provided by another device, including but not limited to, a processor, a microprocessor, a controller, a digital signal processor (DSP), a field-programmable gate array (FPGA), or discrete logic circuitry. The functions attributed to ASIC 48 described herein may also be embodied in a processor or device via software, firmware, hardware or any combination thereof.

Angular position sensor device 14 may include further elements than the example shown in FIG. 2. For example, angular position sensor device 14 may include an internal temperature reference for temperature measurement and error correction of the signals generated from the AMR sensors 40 and 42. In another example, angular position sensor device 14 may include a controller that may calculate a normalized bridge output value generated by one of the AMR sensors 40 and 42.

Angular position sensor device 14 may further include one or more storage devices for storing calibration coefficients for at least one of the AMR sensors 40 and 42. A storage device may also include one or more computer-readable storage media and may be configured for long-term storage of information. In some examples, a storage device may include non-volatile storage elements. Examples of such non-volatile storage elements may include, but are not limited to, magnetic hard discs, optical discs, floppy discs, flash memories, or forms of electrically programmable memories (EPROM) or electrically erasable and programmable (EEPROM) memories. In some examples, angular position sensor device 14 may include a storage device, such as an EEPROM, in order to store an initial orientation of incident magnetic field 20. The initial orientation may be used to determine the absolute position of incident magnetic field 20 in examples where a polarity sensor 54 or 56 is not in use.

In some examples, angular position sensor device 14 may utilize one or more communication devices to wirelessly communicate with a device external to angular position sensor device 14. Angular position sensor device 14 may include, or be communicatively coupled to, a communication device. Such a communication device may comprise a network interface card for communicating with ASIC 48 or for receiving data from a storage device. In one example, one or more communication devices 30 may comprise an Ethernet card, configured to communication over, for example, Ethernet, transmission control protocol (TCP), Internet protocol (IP), asynchronous transfer mode (ATM), or other network communication protocols. In other examples, a communication device may be an optical transceiver, a radio frequency transceiver, or any other type of device that can send and receive information. In one example, a communication device may comprise an antenna.

Examples of such a communication device may include Bluetooth®, 3G, WiFi®, very high frequency (VHF), and ultra high frequency (UHF) radios. Communication devices 30 may also be configured to connect to a wide-area network such as the Internet, a local-area network (LAN), an enterprise network, a wireless network, a cellular network, a telephony network, a Metropolitan area network (e.g., Wi-Fi, WAN, or WiMAX), one or more other types of networks, or a combination of two or more different types of networks (e.g., a combination of a cellular network and the Internet).

Angular position sensor device 14 may also include one or more batteries, which may be rechargeable in some examples and provide voltage to AMR sensors 40 and 42 and ASIC 48. The one or more batteries may be made from nickel-cadmium, lithium-ion, or any other suitable material. In one example, one or more batteries may provide a voltage to AMR sensors 40 and 42 at nodes 44 and 46, respectively. In other examples, an external power source provides power to angular position sensor device 14.

One example of ASIC 48 may comprise a Sleipnir ASIC, available from Honeywell International, Inc. Sleipnir is an ASIC platform that may be used for MR based position sensing applications. The Sleipner ASIC may use SIN, COS, −SIN, and −COS functions for Br0, Br1, Br2, and Br3, respectively, to cover the first 180 degrees angular range. In one example, the Sleipner ASIC may use a maximum differential (maxdiff) function as well. A maxdiff function within ASIC 48 detects a bridge pair that has the greatest difference between the two input signals. The bridge pair with the greatest difference is the bridge pair with the magnetic target within the pair. The techniques of this disclosure are designed to work well with the Sleipner ASIC, although similar techniques may also be used with other ASICs.

FIG. 4 is a graph illustrating waveforms generated by an example sensing device, in accordance with one or more aspects of the present disclosure. The graph illustrates one example of voltage difference signals determined at bridges of an ASIC, such as ASIC 48 as in FIG. 2. The sensing device may be angular position sensor device 14, also as in FIG. 2. The depicted waveforms 70, 72, 74, 76, 78, 80, 82, and 84 correspond to ASIC 48 bridges Br0, Br1, Br2, Br3, Br4, Br5, Br6, and B57, respectively.

The graph of FIG. 4 shows an angle range in degrees from approximately −360 to 0 degrees, however, other angle ranges may be provided in other examples. Waveforms 70 through 84 may be sinusoidal difference signals. As shown in FIG. 4, waveforms 70 through 84 are digital counts generated from subtracting two analog voltage signals and converting the difference into a digital signal. Calculating a voltage difference across each of AMR sensors 40 and 42 results in two sinusoidal signals that are 90 degrees out of phase from each other. For example, waveform 70 may be a voltage difference across AMR sensor 40 and waveform 72 may be a voltage difference across AMR sensor 42. Waveform 70 may be digital. These difference waveforms have two electric cycles for each mechanical cycle of a complete rotation of incident magnetic field 20. By continuing to sample the voltage differences over more than 180 degrees, digital waveforms 78 and 80 are also determined. Inverse signals for each waveform 70, 72, 78, and 80 are also calculated, for waveforms 74, 76, 82, and 84, respectively. Through signal processing, ASIC 48 is able to use these signals to generate a decoded angular position signal 32 having an angle range beyond the 180 degree range of the AMR sensor 40 and 42.

One example way of generating waveforms 70 though 84 is as follows. Br0 receive a first signal from a first magnetic field angular position sensor, such as first AMR sensor 40, at a positive input of Br0 and a second signal from the first magnetic field angular position sensor at a negative input of Br0. ASIC 48 subtracts the second signal of first AMR sensor 40 from the first signal of first AMR sensor 40. Over an angular range of approximately 360 degrees of an incident magnetic field on first AMR sensor 40, sinusoidal waveform 70 is generated. Sinusoidal waveform 70 may be generated by amplifying and converting the analog sensor signals to digital.

Inversely, Br2 receives the second signal from first AMR sensor 40 at a positive input and the first signal from first AMR sensor 40 at a negative input. ASIC 48 subtracts the first signal of first AMR sensor 40 from the second signal of first AMR sensor 40, thus generating waveform 74. Waveform 74 may be an inverse of waveform 70.

Similarly, Br1 receives a first signal from a second magnetic field angular position sensor, such as second AMR sensor 42, at a positive input and a second signal from the second magnetic field angular position sensor at a negative input. ASIC 48 subtracts the second signal of second AMR sensor 42 from the first signal of second AMR sensor 42. Over an angular range of approximately 360 degrees of an incident magnetic field on second AMR sensor 42, sinusoidal waveform 72 is generated. As shown in FIG. 4, the signal at bridges 4 through 7 may be a continuation of the signal at bridges 0 through 3. Similar to that described above with respect to waveform 74, waveform 76 is generated as the inverse of waveform 72.

Br4 receives the first signal from first AMR sensor 40 at a positive input of Br4 and an output signal from a drain of a first transistor, such as transistor 50, at a negative input of Br4. Transistor 50 may receive the first signal from first AMR sensor 40 at a source, and transistor 50 may be enabled by a first polarity sensor 54 at a gate. Br4 may generate waveform 78. Br6 may determine the inverse of waveform 78, and generate waveform 82.

Similarly, Br5 receives the first signal from second AMR sensor 44 at a positive input and an output signal from a drain of a second transistor, such as transistor 52, at a negative input. Transistor 52 may receive the first signal from second AMR sensor 42 at a source and a polarity signal at a gate. Br5 may generate waveform 80. Inversely, Br7 may determine the inverse of waveform 80, and generate waveform 84.

ASIC 48 may perform a Fourier series on the waveforms 70, 72, 74, 76, 78, 80, 82, and 84 at the bridges Br0 through Br7 in order to generate decoded angular position signal 32. Angular position sensor device 14 may convert two sinusoidal cycles into a 360 degree angular range signal.

In other examples, ASIC 48 may combine the signals from two or more consecutive bridges in order to generate a single linear output across an entire sensing band (for example, 360 degrees of rotating incident magnetic field 20). For example, every two consecutive bridges may be a bridge pair. The responses from both bridges in a pair may be combined to form a linear response over the entire sensing band. For example, Br0 and Br 1 may make a first bridge pair that results in a linear response over sensing band from approximately 0 degrees to 45 degrees. Similarly, Br1 and Br2 may be combined to generate a linear response over the sensing band from approximately 45 degrees to 90 degrees. Bridge pairs may be combined in this way to cover an entire 360 degree sensing band.

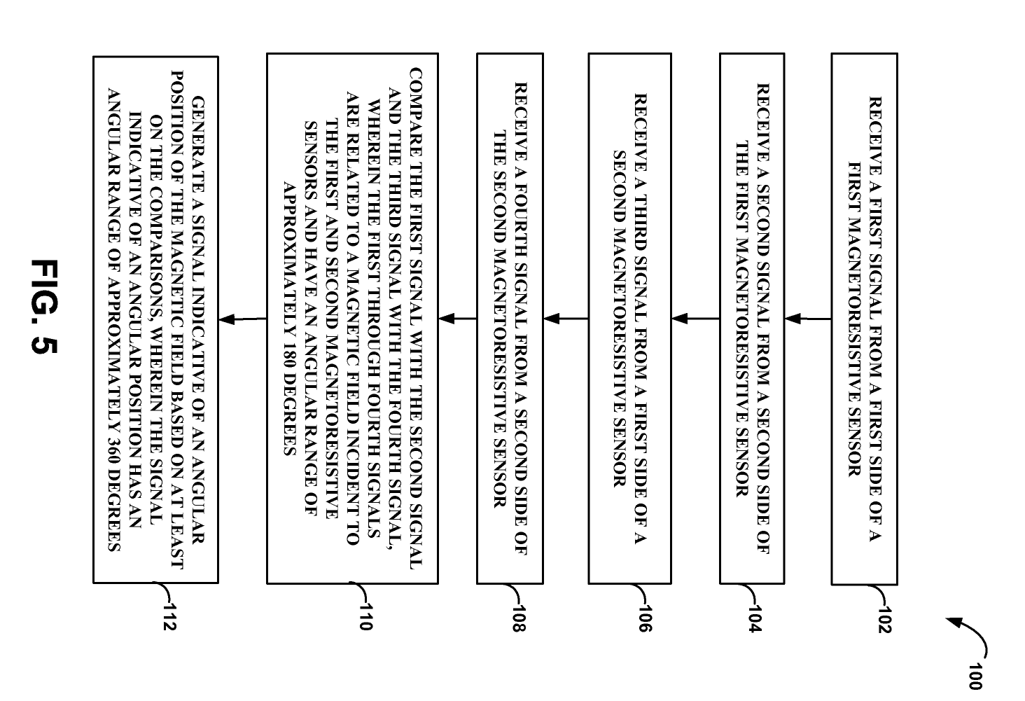

FIG. 5 is a flowchart illustrating an example method 100 for determining an angular position of a magnetic field source, in accordance with one or more aspects of the present disclosure. Method 100 may be performed, for example, by angular position sensor device 14 of FIGS. 1 and 2. However, method 100 may be performed by other examples of an angular position sensor device in accordance with one or more aspects of the present disclosure.

Method 100 may comprise receiving a first signal from a first side of a first magnetoresistive sensor (102) and receiving a second signal from a second side of the first magnetoresistive sensor (104). Method 100 may further comprise receiving a third signal from a first side of a second magnetoresistive sensor (106) and receiving a fourth signal from a second side of the second magnetoresistive sensor (108). In one example, the second magnetoresistive sensor is oriented at least approximately 90 degrees with respect to the first magnetoresistive sensor.

Method 100 may further comprise comparing the first signal with the second signal and the third signal with the fourth signal (110). Also, method 100 may further include comparing each two consecutive signals. That is, the second signal may be compared with the third signal, fourth signal with a fifth signal, fifth signal with a sixth signal, etc. The first through fourth signals may be related to a magnetic field incident to the first and second magnetoresistive sensors and have an angular range of approximately 180 degrees. Method 100 may further include generating a signal indicative of an angular position of the magnetic field based on at least on the comparisons, wherein the signal indicative of an angular position had an angular range of approximately 360 degrees (112).

In some examples, comparing the first signal with the second signal and the third signal with the fourth signal (110) may further include performing a binary operation on the respective signals. The binary operation may be a subtraction. For example, a first difference voltage signal may be calculated by subtracting the second signal from the first signal. Likewise, a second difference voltage signal may be calculated by subtracting the fourth signal from the third signal. An inverse of the first difference voltage signal may be determined by subtracting the first signal from the second signal. Similarly, an inverse of the second difference voltage signal may be determined by subtracting the third signal from the fourth signal.

Method 100 may include rotating a magnetic field source proximate to the first and second magnetoresistive (MR) sensors. In some examples, a distance of the magnetic field source from the MR sensors remains approximately the same. Method 100 may further include performing a linearization using the Fourier series of at least on the first difference voltage signal, the second difference voltage signal, the first inverse signal, and the second inverse signal. Method 100 may further include amplifying the difference voltage signals and converting the difference voltage signals to digital signals.

An initial orientation of an incident magnetic field may be determined, and may or may not be stored in a storage device. In some examples, the initial orientation may be determined using a polarity sensor. Method 100 may further include calculating an absolute position of the magnetic field based on the initial orientation of the magnetic field. The output signal indicative an angular position of the magnetic field may be related to the absolute position of the magnetic field.

Method 100 may further include providing the first signal to a source of a first transistor and providing the second signal to a source of a second transistor. In other examples, Method 100 provides the first and second signals to another semiconductor device, a multiplexer, or a digital logic circuit. The first transistor may be enabled with a polarity signal from a polarity sensor during approximately half of a rotation cycle of the magnetic field, wherein the polarity sensor is coupled to a gate of the first transistor. Likewise, the second transistor may be enabled with the polarity signal during the approximately half of the rotation cycle of the magnetic field, wherein the polarity sensor is coupled to a gate of the second transistor.

The two magnetoresistive sensors may be approximately aligned with an axis of rotation of the incident magnetic field, wherein a magnetic field source is affixed to a rotatable device approximately over the axis of rotation. Because techniques of this disclosure use two magnetoresistive sensors, as opposed to an array of sensors, the rotary position sensor device may be centered over the magnetic field source. This may reduce a complexity of assembling, installing, and calibrating angular position sensor devices according to aspects of the present invention.

In the manners described above, the techniques of this disclosure may provide an angular position sensing signal with an increased angular range relative to that which is generated by magnetoresistive angular position sensors. The angular position signal may be a digital signal that is linear over approximately 360 degrees. Two magnetic field angular position sensors, such as AMR sensors, may be packaged into a single device which may be centrally located over a magnetic field source.

Techniques described herein may be implemented, at least in part, in hardware, software, firmware, or any combination thereof. For example, various aspects of the described embodiments may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein may also be embodied or encoded in an article of manufacture including a computer-readable storage medium encoded with instructions. Instructions embedded or encoded in an article of manufacture including an encoded computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

In some examples, computer-readable storage media may comprise non-transitory or tangible media. The term “non-transitory” may indicate that the storage medium is not embodied in a carrier wave or a propagated signal. In certain examples, a non-transitory storage medium may store data that can, over time, change (e.g., in RAM or cache). Further, the term “tangible” may indicate that the storage medium is not embodied in a carrier wave or a propagated signal.

Various aspects of the disclosure have been described. Aspects or features of examples described herein may be combined with any other aspect or feature described in another example. These and other examples are within the scope of the following claims.

1. A rotary position sensor, comprising:
an integrated circuit;
a first magnetic field angular position sensor that provides at least a first signal to the integrated circuit; and
a second magnetic field angular position sensor that provides at least a second signal to the integrated circuit;
wherein the integrated circuit is configured to provide an output signal indicative of an angular position of a magnetic field, wherein the output signal is based at least on the first signal and the second signal, and wherein the output signal has an angular range of approximately 360 degrees.

2. The rotary position sensor of claim 1, wherein the first magnetic field angular position sensor comprises a first anisotropic magnetoresistive (AMR) sensor and the second magnetic field angular position sensor comprises a second AMR sensor.

3. The rotary position sensor of claim 2,
wherein the first AMR sensor comprises a first Wheatstone bridge positioned in a first orientation, and
wherein the second AMR sensor comprises a second Wheatstone bridge positioned in a second orientation, wherein the second orientation is rotated approximately ninety degrees with respect to an orientation of the first orientation.

4. The rotary position sensor of claim 3,
wherein the first signal comprises a voltage at a first side of the first Wheatstone bridge,
wherein the second signal comprises a voltage at a first side of the second Wheatstone bridge,
wherein the first Wheatstone bridge further provides a third signal to the integrated circuit, wherein the third signal comprises a voltage at a second side of the first Wheatstone bridge,
wherein the second Wheatstone bridge further provides a fourth signal to the integrated circuit, wherein the fourth signal comprises a voltage at a second side of the second Wheatstone bridge, and
wherein the output signal is based on the first signal, the second signal, the third signal and the fourth signal.

5. The rotary position sensor of claim 1, wherein the integrated circuit is an application specific integrated circuit (ASIC).

6. The rotary position sensor of claim 5, further comprising:
a first transistor coupled between the first magnetic field angular position sensor and the ASIC; and
a second transistor coupled between the second magnetic field angular position sensor and the ASIC.

7. The rotary position sensor of claim 6, further comprising:
a polarity detector coupled to at least a gate of the first transistor.

8. The rotary position sensor of claim 6, wherein the ASIC comprises:
a first bridge that receives the first signal from the first magnetic field angular position sensor at a positive input of the first bridge and a second signal from the first magnetic field angular position sensor at a negative input of the first bridge;
a second bridge that receives the second signal from the first magnetic field angular position sensor at a positive input of the second bridge and the first signal from the first magnetic field angular position sensor at a negative input of the second bridge;
a third bridge that receives the first signal from the second magnetic field angular position sensor at a positive input of the third bridge and a second signal from the second magnetic field angular position sensor at a negative input of the third bridge;
a fourth bridge that receives the second signal from the second magnetic field angular position sensor at a positive input of the fourth bridge and the first signal from the second magnetic field angular position sensor at a negative input of the fourth bridge;
a fifth bridge that receives the second signal from the first magnetic field angular position sensor at a positive input of the fifth bridge and an output signal from a drain of the first transistor at a negative input of the fifth bridge, wherein a source of the first transistor receives the first signal from the first magnetic field angular position sensor;
a sixth bridge that receives the output signal from the drain of the first transistor at a positive input of the sixth bridge and the second signal from the first magnetic field angular position sensor at a negative input of the sixth bridge;
a seventh bridge that receives the second signal from the second magnetic field angular position sensor at a positive input of the seventh bridge and an output signal from a drain of the second transistor at a negative input of the seventh bridge, wherein a source of the second transistor receives the first signal from the second magnetic field angular position sensor; and
an eighth bridge that receives the output signal from a drain of the second transistor at a positive input of the eighth bridge and the second signal from the second magnetic field angular position sensor at a negative input of the eighth bridge.

9. A system, comprising:
a magnetic field source having a magnetic field;
a rotary position sensor in proximity to the magnet and configured to determine an orientation the magnetic field, comprising:
an application specific integrated circuit (ASIC);
a first magnetoresistive sensor that provides a first signal to the ASIC; and
a second magnetoresistive sensor that provides a second signal to the ASIC;
wherein the ASIC is configured to provide an output signal indicative of the orientation of the magnetic field, wherein the output signal is based at least on the first signal, the second signal, an inverse of the first signal, and an inverse of the second signal.

10. The system of claim 9, further comprising:
a rotatable device, wherein the magnetic field source is affixed to the rotatable device approximately over an axis of rotation of the rotatable device;
wherein the rotary position sensor is located approximately aligned with the magnetic field source.

11. The system of claim 9, wherein the output signal has an approximate range of 360 degrees.

12. The system of claim 9, wherein an orientation of the second magnetoresistive sensor is rotated at least approximately ninety degrees with respect to an orientation of the first magnetoresistive sensor.

13. The system of claim 9, wherein the rotary position sensor further comprises:
a first transistor coupled between the first magnetoresistive sensor and the ASIC;
a second transistor coupled between the second magnetoresistive sensor and the ASIC; and
a polarity sensor coupled to a gate of the first transistor and the second transistor.

14. A method for determining rotary position, comprising:
receiving a first signal from a first side of a first magnetoresistive sensor;
receiving a second signal from a second side of the first magnetoresistive sensor;
receiving a third signal from a first side of a second magnetoresistive sensor, wherein the second magnetoresistive sensor is oriented at least approximately 90 degrees with respect to the first magnetoresistive sensor;
receiving a fourth signal from a second side of the second magnetoresistive sensor;
comparing the first signal with the second signal and the third signal with the fourth signal, wherein the first through fourth signals are related to a magnetic field incident to the first and second magnetoresistive sensors and have an angular range of approximately 180 degrees; and
generating a signal indicative of an angular position of the magnetic field based on at least on the comparisons, wherein the signal indicative of an angular position has an angular range of approximately 360 degrees.

15. The method of claim 14, wherein comparing further comprises:
subtracting the second signal from the first signal to calculate a first difference voltage signal;
subtracting the fourth signal from the third signal to calculate a second difference voltage signal;
determining a first inverse signal of the first difference voltage signal; and
determining a second inverse signal of the second difference voltage signal.

16. The method of claim 15,
wherein generating a signal indicative of an angular position of the magnetic field is further based on performing a linearization using a Fourier series of at least on the first difference voltage signal, the second difference voltage signal, the first inverse signal, and the second inverse signal.

17. The method of claim 14, further comprising:
providing the first signal to a source of a first transistor;
providing the second signal to a source of a second transistor;
enabling the first transistor with a polarity signal from a polarity sensor during approximately half of a rotation cycle of the magnetic field, wherein the polarity sensor is coupled to a gate of the first transistor; and
enabling the second transistor with the polarity signal during the approximately half of the rotation cycle of the magnetic field, wherein the polarity sensor is coupled to a gate of the second transistor.

18. The method of claim 14, further comprising:
aligning the first magnetoresistive sensor and the second magnetoresistive sensor with approximately an axis of rotation of the magnetic field, wherein a magnetic field source is affixed to a rotatable device approximately over the axis of rotation.

19. The method of claim 14, further comprising:
determining an initial orientation of the magnetic field.

20. The method of claim 19, wherein generating a signal indicative of an angular position of the magnetic field further comprises calculating an absolute position of the magnetic field based on the initial orientation of the magnetic field, and
wherein the signal indicative of an angular position of the magnetic field is related to the absolute position of the magnetic field.
